(19) United States
(12) Patent Application Publication
(10) Pub. No.: US 2015/0020622 A1
(43) Pub. Date: Jan. 22, 2015

(54) TRANSMISSION CONTROL STRUCTURE FOR CURTAIN SYSTEM

(71) Applicant: PINNOKI CO., LTD., Taichung City (TW)

(72) Inventor: Li-Fen Lin, Taichung City (TW)

(21) Appl. No.: 13/944,894

(22) Filed: Jul. 18, 2013

(51) Int. Cl. F16H 19/06

(52) U.S. Cl. CPC F16H 19/0622
USPC 74/89.22

(57) ABSTRACT

A transmission control structure for a curtain system includes a driving set and a transmission set having a base casing having one end formed with a mounting portion, on which an end portion of an upper transverse track of the curtain system is mounted. Also, a pulley wrapped around by a rope of the curtain system is pivotally mounted in the base casing. The driving set has a motor with the controllable forward and reverse rotations and rotating speed. The motor has an output shaft for driving the pulley of the transmission set. Because the mounting portion of the base casing is directly connected to one end portion of the upper transverse track of the existing curtain system, only the existing rope needs to be wound around the pulley of the transmission set. The replacement and modification can be easily made, and the unessential waste can be decreased.

### BACKGROUND OF THE INVENTION

(1) Field of the Invention

The invention relates to the driving technology of a curtain system, and more particularly to a transmission control structure for a curtain system having the high safety and the convenient operation, so as to broaden the application of the solar energy generation and to simplify the mounting and replacing procedures to decrease the unessential waste.

(2) Description of the Prior Art

A curtain system is a building accessory for shielding light and preventing the indoor objects from being arbitrarily peeped by others, and is widely applied to various doors and windows. There are many kinds of curtain systems. However, either the hanging blind, shutter, Roman blind or any other structure design with the vertical or horizontal moving aspect is controlled by a rope or ropes. The conventional control device for the curtain system generally includes: at least one pulley set (e.g., a curtain system opened and closed in the left-right direction) or a reel set (a curtain system that are coiled in the top-bottom direction), a transverse rod pivotally mounted on the curtain system; a transmission mechanism disposed on one end of the transverse rod connected to the transmission mechanism and the pulley set (or reel set); and a ring rope, which is disposed on a lateral side of the window and has a top end connected to the transmission mechanism. The rope can be pulled by the user cyclically. The transmission of the transmission mechanism can rotate the pulley set (or reel set) in a predetermined rotating direction. The movable curtain of the curtain system is connected to the pulley set (or reel set). Thus, when the pulley set (or reel set) forwards or reverses, the curtain can be moved leftwards or rightwards to develop or close (or coil upwards or release rightwards) so that the movable blind of the curtain system is retracted upwards or developed downwards.

The common drawback of the above-mentioned conventional transmission control devices resides in that the rope is hung from the lateral side of the window, and the rope may intertwine with the human body accidentally. More particularly, the kid's neck tends to be twined by the rope, so that the safety in use is poor. Attentions to these deathful dangers hidden in the home life should be indeed paid.

In order to solve the safety problem of the rope of the curtain system, various products capable of overcoming the rope problem using various technological means have been developed. However, the overall structure is still too complicated. Usually, the overall set of upper transverse track, pulley set (or reel set), transmission mechanism and the like has to be replaced. Thus, the replacement is inconvenient because the upper transverse track, the pulley set (or reel set) and the transmission mechanism, which have not been damaged, also have to be discarded to cause the unessential waste. So, the prior art cannot satisfy the actual requirement in use, and needs to be improved. How to solve this problem is the important subject in this industry.

### SUMMARY OF THE INVENTION

A main object of the invention is to provide a transmission control structure for a curtain system having the high safety. The forward and reverse rotations of a stepping motor can be used to pull the rope to directly operate the curtain system to develop and retract the curtain.

Thus, the laborsaving effect and easy operation effect can be obtained. In addition, it is unnecessary to hang a redundant rope on one side of the window to prevent the neck from being accidentally twined, and to effectively enhance the safety and convenience in use.

Also, another main object of the invention is to provide a transmission control structure for a curtain system, in which the replacement can be easily performed. The transmission control structure can be directly assembled with one end of the upper transverse track. The installation can be completed after cutting off the redundant portion of the original rope without replacing the overall set. So, the unessential waste can be avoided.

The invention mainly achieves the objects and performance through the following technological means. The curtain system has an upper transverse track, and a rope is disposed on the upper transverse track. The rope can move at least one curtain, disposed below the upper transverse track, to be developed or retracted. The characteristic lies in that: the transmission control structure comprising a transmission set and a driving set is disposed on one end portion of the upper transverse track; the transmission set has a base casing, wherein one end of the base casing is formed with a mounting portion, on which the end portion of the upper transverse track is mounted, and a pulley to be wrapped around by the rope is pivotally mounted in the base casing; and the driving set may be disposed on the transmission set, a motor with controllable forward and reverse rotations and a controllable rotating speed is disposed in the driving set, and the motor has an output shaft capable of synchronously driving the pulley of the transmission set.

With the embodied implementation of the technological means, the curtain of the curtain system of the invention can be driven by the transmission control structure. Because the rope wraps around the pulley of the transmission set, the rope cannot be exposed and hung, so that the accident of twining around the neck can be avoided, and the safety is effectively enhanced. In addition, the curtain can be controlled by the electric driving set, thereby significantly enhancing the operation convenience. In addition, the mounting portion of the base casing of the transmission set is directly inserted into and connected to the end portion of the upper transverse track of the existing curtain system. So, the modification can be completed by wrapping the rope around the pulley of the transmission set and then cut off the redundant rope without removing the overall set of upper transverse track. Thus, the replacement and modification are easy, the unessential waste can be reduced, and the utility thereof can be effectively enhanced.

Further aspects, objects, and desirable features of the invention will be better understood from the detailed description and drawings that follow in which various embodiments of the disclosed invention are illustrated by way of examples.

### BRIEF DESCRIPTION OF THE DRAWINGS

FIG. 1 is a schematic illustration showing the exterior of a curtain system applying the invention.

FIG. 2 is a pictorially decomposed schematic illustration showing a transmission control structure for the curtain system of the invention, and showing aspects of and relative relationships between the assemblies.

FIG. 3 is a pictorially decomposed schematic illustration showing a driving set in the transmission control structure for the curtain system of the invention.

FIG. 4 is a schematic illustration showing the exterior of the transmission control structure for the curtain system of the invention.

FIG. 5 is a schematically cross-sectional side view showing the transmission control structure for the curtain system of the invention.

FIG. 6 is a schematic top view showing the operation of the transmission control structure for the curtain system of the invention.

### DETAILED DESCRIPTION OF THE PREFERRED EMBODIMENTS

The invention provides a transmission control structure for a curtain system. In the following detailed description of the preferred embodiments and the members thereof, reference is made to the accompanying drawings which form a part hereof. In this regard, directional terminology, such as “front,” “rear,” “left,” “right”, “top,” “bottom,” “horizontal,” and “vertical” is used with reference to the orientation of the drawing(s) being described. The components of the present invention can be positioned in a number of different orientations. As such, the directional terminology is used for purposes of illustration and is in no way limiting. On the other hand, the drawings are only schematic and the sizes of components may be exaggerated for clarity, so the sizes can be changed according to the design and requirement in the embodiment of the invention without departing from the scope of the invention.

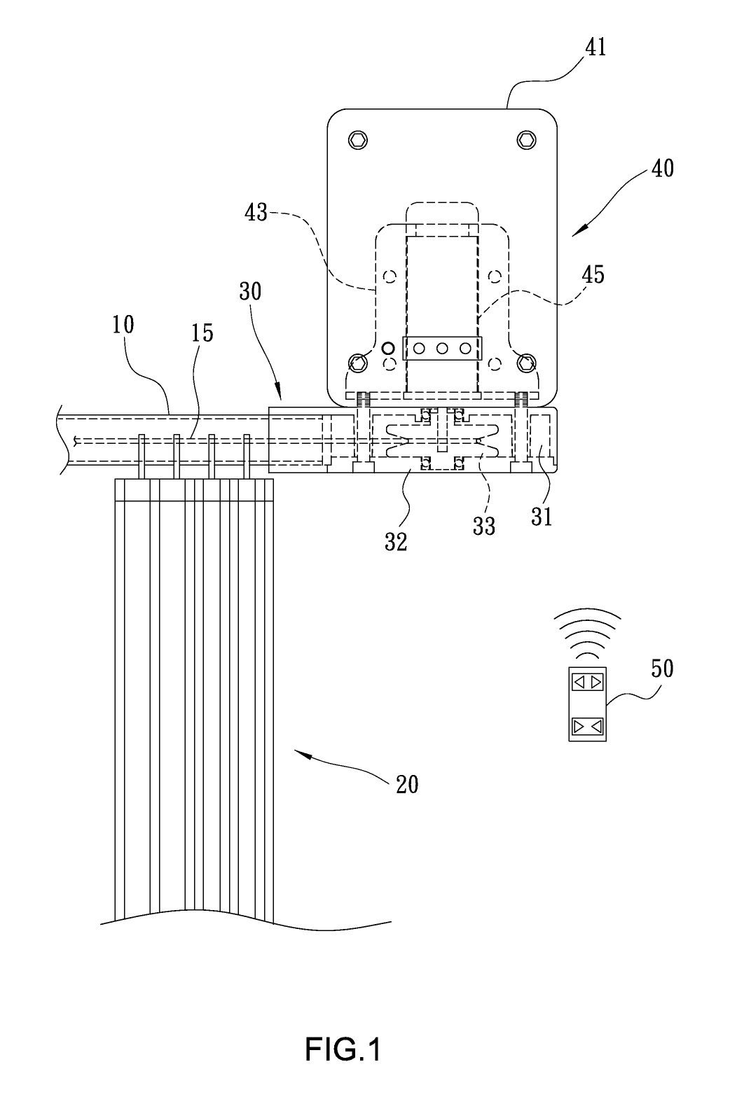

The invention provides the transmission control structure for the curtain system, as shown in FIG. 1. The curtain system has an upper transverse track 10. A rope 15 is disposed on the upper transverse track 10. The rope 15 can drive at least one curtain 20, disposed below the upper transverse track 10, through the transmission control structure to control the curtain 20 to be developed or retracted. The construction and operation principle of the curtain system are the same as those of the existing art, and do not pertain to the characteristic of the invention, so detailed descriptions thereof will be omitted.

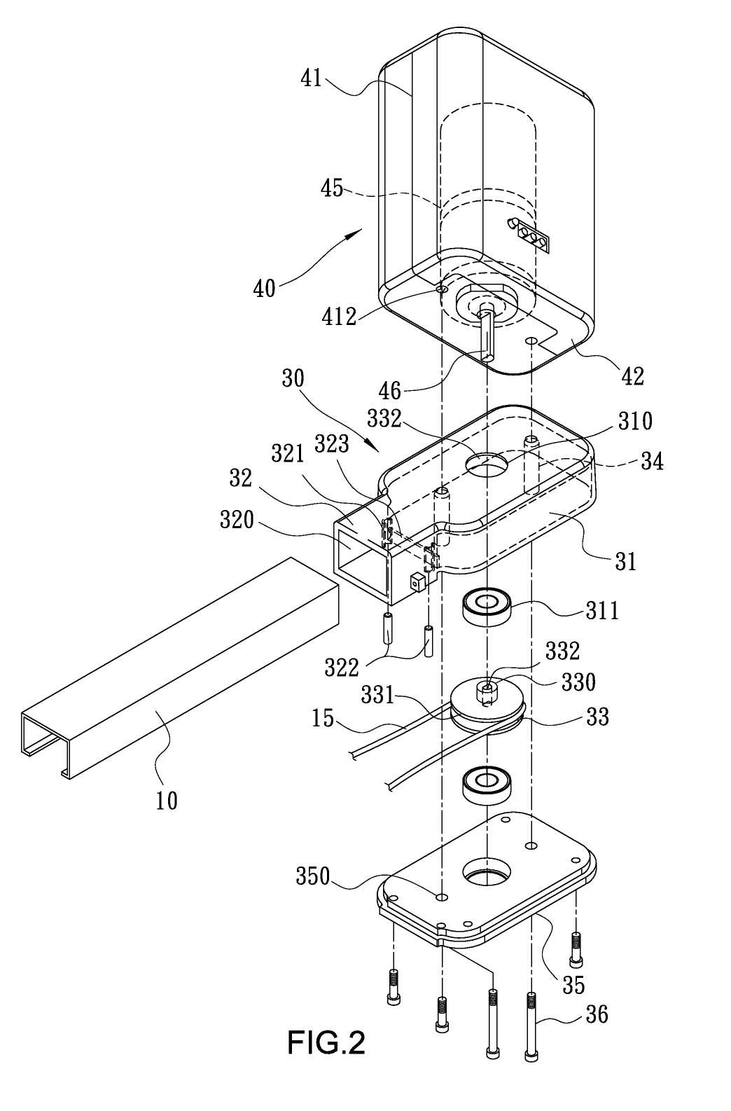

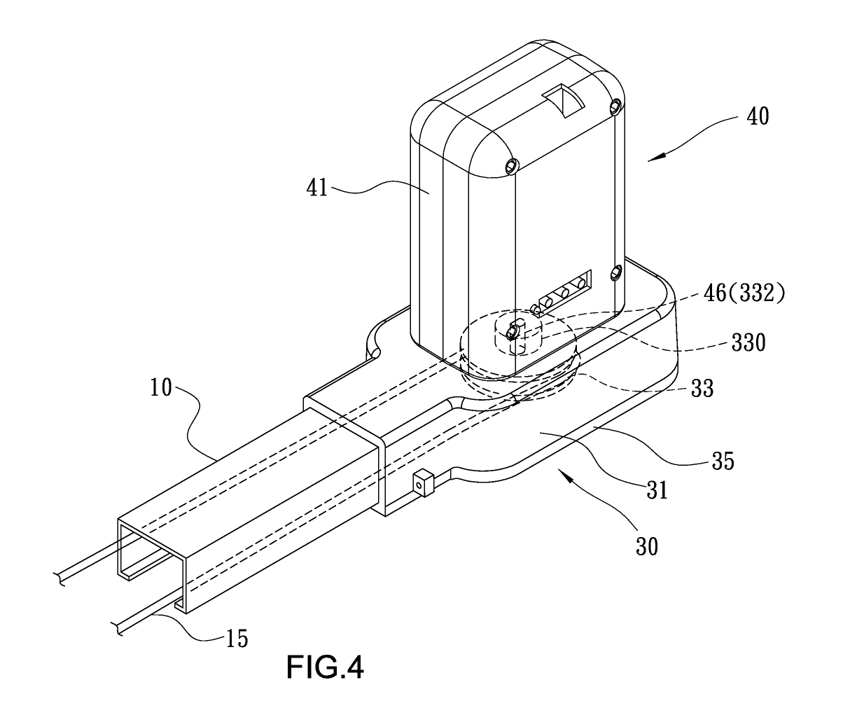

The characteristic of the invention resides in the transmission control structure, as shown in FIGS. 2 to 4. The transmission control structure includes a transmission set 30, a driving set 40 and a control set 50.

The transmission set 30 has a base casing 31. The base casing 31 is formed with an internal space with an opening. One end of the base casing 31 is formed with a mounting portion 32 to be mounted on the end portion of the upper transverse track 10. The mounting portion 32 has a mounting hole 320 communicating with the internal space. A fixing slot 321 is formed on each of two lateral inner sides of the mounting hole 320 near the internal space. A metal cylinder 322 can be embedded into the fixing slot 321, which exposes a portion of a circular arc surface of the metal cylinder 322 in the mounting hole 320 to provide the friction upon rotation of the rope 15. In addition, a raising plate 323 transversally crosses the fixing slot 321 near the internal space. The raising plate 323 is provided such that the rope 15 cannot be close to the bottom of the internal space when the installation worker is installing the rope 15 so that the installation of the worker is facilitated. Furthermore, the end portion of the upper transverse track 10 can be inserted into and connected to the mounting hole 320 of the mounting portion 32. Also, a bearing seat 310 having a through hole is formed on the base casing 31. A bearing 311 for the pivotal connection to a pulley 33 is disposed in the bearing seat 310. The pulley 33 has a shaft 330 pivotally mounted in the bearing 311 of the base casing 31. An exposed end surface of the shaft 330 is formed with a polygonal driving hole 332, so that the driving set 40 can synchronously drive the pulley 33. Furthermore, a rope slot 331 is formed on a circumference of the pulley 33, so that the rope 15 in the upper transverse track 10 can wrap around the pulley 33 and is pulled by the action of the pulley 33. In addition, the internal space of the base casing 31 is formed with two screw cylinders 34 disposed on two sides of the axis of the bearing seat 310, respectively. The opening of the base casing 31 is covered with a cover plate 35 having a through hole 350 corresponding to the screw cylinder 34, so that a corresponding screwing member 36 may be utilized to screw the cover plate 35 onto the base casing 31 and further to screw, from bottom to top, the driving set 40.

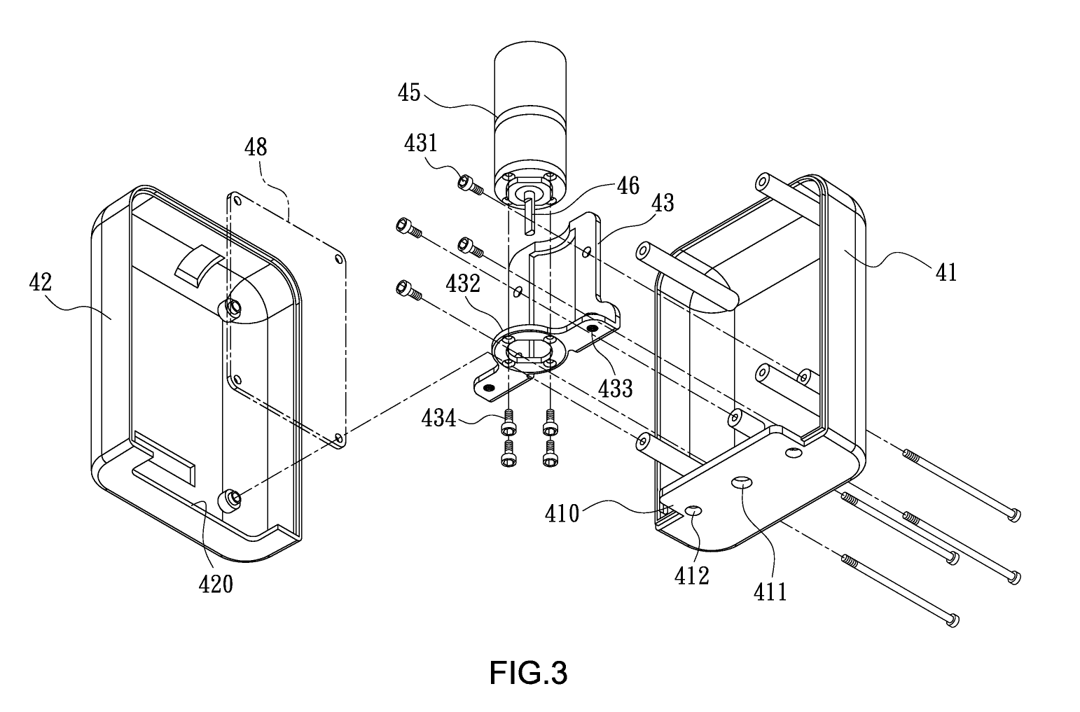

In addition, as shown in FIG. 3, the driving set 40 has two housings 41, 42 capable of closing upon each other, and a motor 45 capable of driving the pulley 33 of the transmission set 30 is disposed in the two housings 41, 42. Also, the end portions of the two housings 41, 42 corresponding to the base casing 31 are formed with a tab 410 and a notch 420 capable of relatively embedding with each other. The housing 41 with the tab 410 is formed with a shaft hole 411 at the middle of the tab 410. In addition, the tab 410 is formed with through holes 412 disposed on two sides of the axis of the shaft hole 411, so that the screwing member 36 of the base casing 31 of the transmission set 30 can pass through the shaft hole 411. Furthermore, a plurality of screwing elements 431 is utilized to screw a buffer seat 43 to the housing 41. The buffer seat 43 has a folded sheet 432 corresponding to the tab 410. The folded sheet 432 can be screwed to the motor 45 using a plurality of screwing elements 434. Each of two sides of the folded sheet 432 of the buffer seat 43 is formed with a screwing hole 433 corresponding to the through hole 412 of the housing 41 so that the screwing member 36 of the transmission set 30 can be screwed to the screwing hole 433, and the driving set 40 can be screwed to the transmission set 30 in different directions using the through hole 412 and the screwing hole 433 on the center line. Furthermore, a motor 45 having the forward and reverse rotations and the rotating speed that can be controlled is disposed in the housing 41. The motor 45 may be selected as a stepping motor or a servo motor. Also, the motor 45 has a polygonal output shaft 46 penetrating through the shaft hole 411 of the tab 410 of the housing 41. The output shaft 46 can be inserted into the driving hole 332 of the pulley 33 of the transmission set 30 so that the motor 45 of the driving set 40 can synchronously forward and reverse the pulley 33 in the transmission set 30. A circuit board 48 is disposed in the other housing 42. The circuit board 48 can control the forward and reverse rotations and the speed of the motor 45.

The control set 50 is connected to the driving set 40 and may be connected to the circuit board 48 of the driving set 40 in a wired or wireless manner so that the control set 50 can control the forward and reverse rotations and the rotating speed of the motor 45 of the driving set 40 in a wired or wireless manner, and that the curtain 20 can be controlled to develop and retract through the pulley 33 and the rope 15. In the invention, the wireless manner is adopted as the main embodiment.

Thus, the transmission control structure for the curtain system, which can be easily operated and has the high safety, is constructed.

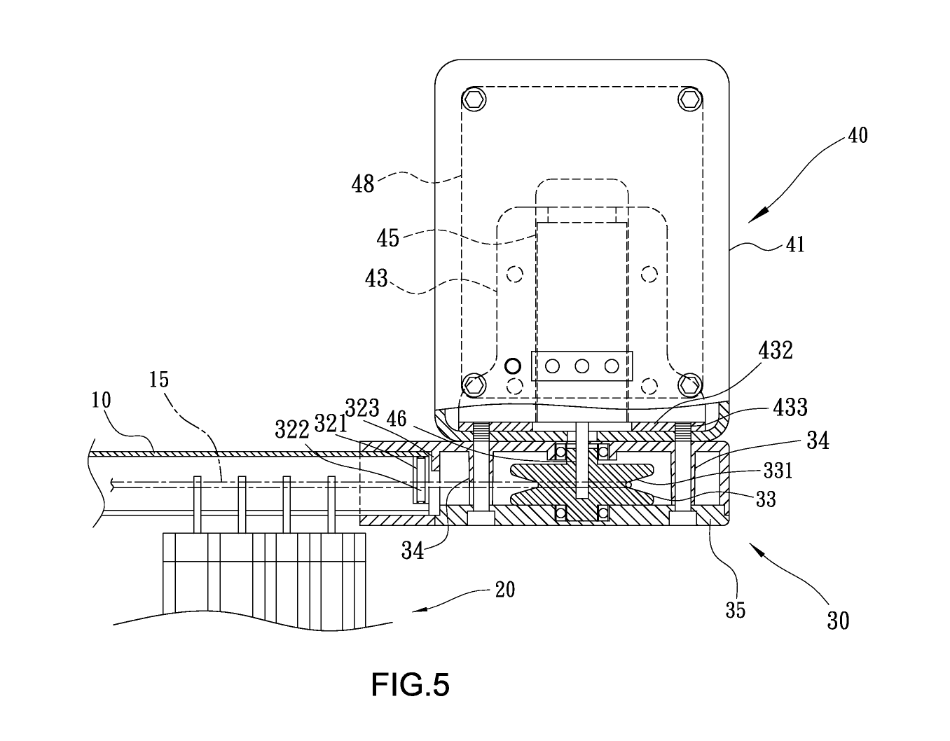

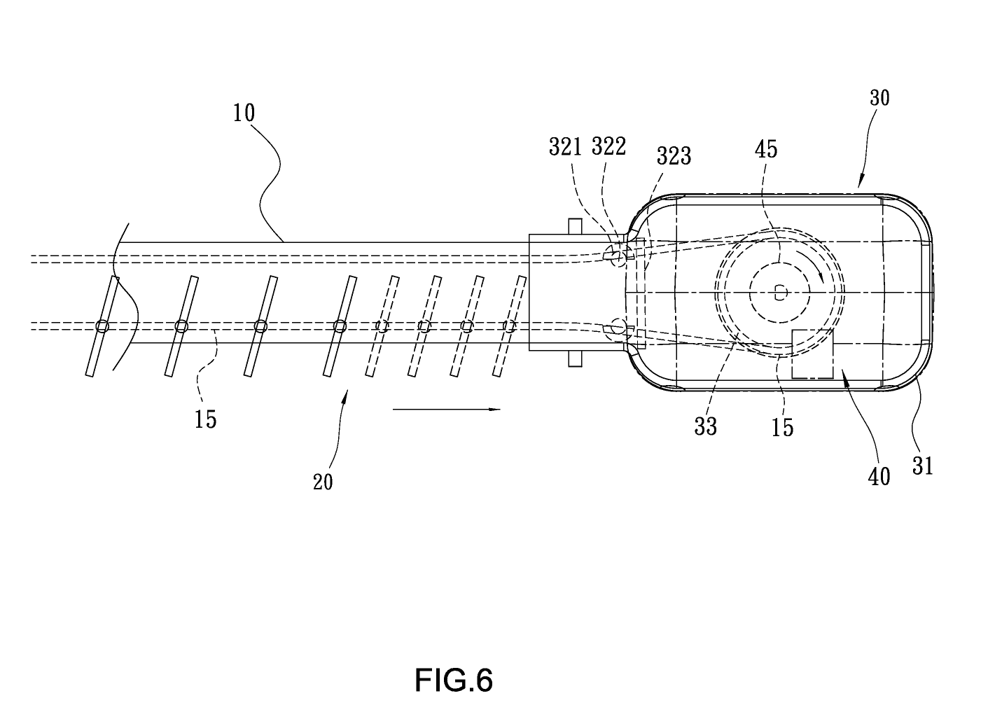

The actual application of the transmission control structure for the curtain system of the invention is shown in FIGS. 1, 4, 5 and 6. In operation, the user only needs to push the developing or retracting button on the control set 50 to control the output shaft 46 of the motor 45 to forward or reverse according to the requirement through the circuit board 48 of the driving set 40. When the output shaft 46 of the motor 45 rotates, the pulley 33 in the transmission set 30 can be synchronously driven, and the rotating pulley 33 can further pull the rope 15 in the upper transverse track 10 in the forward and reverse rotations, thereby synchronously driving the curtain 20 on the upper transverse track 10 to develop or retract and stop at the desired position.

According to the above-mentioned design and described operation, the invention enables the curtain 20 of the curtain system to be controlled and driven by the transmission control structure through the embodied technological means. Because the rope 15 wraps around the pulley 33 of the transmission set 30 and cannot be exposed and hung, the accident of twining around the neck can be avoided, thereby effectively enhancing the safety. In addition, the curtain 20 can be driven by the electric driving set 40, thereby significantly enhancing the operation convenience.

Next, the transmission control structure of the invention can be directly inserted into and connected to the end portion of the upper transverse track 10 of the existing curtain system by using the mounting portion 32 of the base casing 31 of the transmission set 30, wrapping the existing rope 15 around the pulley 33 of the transmission set 30, and then cutting off the redundant portion to complete the modification without removing the overall set of upper transverse track 10. So, the replacement is easy, and the unessential waste can be reduced.

Furthermore, the motor 45 of the driving set 40 of the invention is screwed into the housing 41 through the buffer seat 43, so that the unessential vibration can be decreased, and the damage to the components caused by vibration can be avoided.

Also, the driving set 40 of the invention can be screwed onto the transmission set 30 in different directions using the through hole 412 and the screwing hole 433 on the center line, thereby enhancing the added value and enhancing the economic effectiveness thereof.

In summary, it is understood that the invention is a utility invention with the excellent creativeness. In order to solve the conventional problems effectively, the effect is further significantly enhanced. In addition, no product invention or public use the same or similar to the invention in the same technical field has been found, and the invention has the enhanced effect. So, the invention satisfies the requirements of novelty and the inventive step, and is thus filed as this patent application.

New characteristics and advantages of the invention covered by this document have been set forth in the foregoing description. It is to be expressly understood, however, that the drawings are for the purpose of illustration only and are not intended as a definition of the limits of the invention. Changes in methods, shapes, structures or devices may be made in details without exceeding the scope of the invention by those who are skilled in the art. The scope of the invention is, of course, defined in the language in which the appended claims are expressed.

What is claimed is:

1. A transmission control structure for a curtain system, wherein the curtain system has an upper transverse track, a rope is disposed on the upper transverse track, the rope can move at least one curtain, disposed below the upper transverse track, to be developed or retracted, and the characteristic lies in that:
the transmission control structure comprising a transmission set and a driving set is disposed on one end portion of the upper transverse track;
the transmission set has a base casing, wherein one end of the base casing is formed with a mounting portion, on which the end portion of the upper transverse track is mounted, and a pulley to be wrapped around by the rope is pivotally mounted in the base casing; and
the driving set may be disposed on the transmission set, a motor with controllable forward and reverse rotations and a controllable rotating speed is disposed in the driving set, and the motor has an output shaft capable of synchronously driving the pulley of the transmission set.

2. The transmission control structure according to claim 1, wherein the mounting portion of the base casing of the transmission set has a mounting hole, and the end portion of the upper transverse track can be inserted into and connected to the mounting hole.

3. The transmission control structure according to claim 2, wherein a fixing slot is formed on each of two lateral inner sides of the mounting hole near an internal space, the fixing slot is provided such that a metal cylinder may be embedded into the fixing slot, and a portion of a circular arc surface of the metal cylinder in the mounting hole is exposed, wherein a raising plate transversally crosses the fixing slot near the internal space.

4. The transmission control structure according to claim 1, wherein the pulley of the transmission set has a shaft penetrating through a wall surface of the base casing, an end surface of the shaft is formed with a polygonal driving hole, and an output shaft of the motor of the driving set has a corresponding polygonal shape.

5. The transmission control structure according to claim 1, wherein a circumference of the pulley of the transmission set is formed with a rope slot so that the rope in the upper transverse track can wrap around the pulley.

6. The transmission control structure according to claim 1, wherein the base casing of the transmission set is covered with a cover plate, and the cover plate has a through hole corresponding to a screw cylinder, so that a corresponding screwing member is utilized to screw the cover plate onto the base casing.

7. The transmission control structure according to claim 1, wherein the driving set has two housings capable of closing upon each other, and end portions of the two housings corresponding to the base casing are formed with a tab and a notch capable of relatively embedding with each other, wherein the housing with the tab is formed with a shaft hole at a middle of the tab so that the output shaft of the motor can penetrate through the shaft hole, and the tab is formed with through holes disposed on two sides of an axis of the shaft hole, respectively, and the base casing of the transmission set is formed with a corresponding screw cylinder to be screwed to a corresponding screwing member.

8. The transmission control structure according to claim 6, wherein a buffer seat is screwed to a housing of the driving set using a plurality of screwing elements, the buffer seat has a folded sheet corresponding to a tab, the motor can be screwed to the folded sheet using a plurality of screwing elements, and each of two sides of the folded sheet of the buffer seat is formed with a screwing hole corresponding to the through hole of the housing so that the screwing member of the transmission set can be screwed to the screwing hole.

9. The transmission control structure according to claim 6, wherein a circuit board is disposed in a housing of the driving set, and the circuit board controls the forward and reverse rotations and the speed of the motor.

10. The transmission control structure according to claim 1, wherein the driving set can be controlled by a control set, and the control set can be connected to the driving set in a wired or wireless manner.
